(19) United States
(12) Patent Application Publication
(10) Pub. No.: US 2005/0248276 A1
(43) Pub. Date: Nov. 10, 2005

(54) Phosphorescent phosphor powder, manufacturing method thereof and afterglow fluorescent lamp

(76) Inventors: Koji Nomura, Tokyo (JP); Kenji Ishibashi, Tokyo (JP)

Correspondence Address: YOUNG & THOMPSON, 745 SOUTH 23RD STREET, 2ND FLOOR, ARLINGTON, VA, 22202, US

(21) Appl. No.: 11/083,978

(22) Filed: Mar. 21, 2005

(30) Foreign Application Priority Data
Mar. 24, 2004 (JP) 2004-086953

(51) Int. Cl. H01J 61/35; H01J 1/62

(52) U.S. Cl. 313/635; 313/487

(57) ABSTRACT

In an afterglow fluorescent lamp having a structure wherein at least a phosphorescent phosphor layer is set on the internal surface of a glass container, pinholes are prevented from appearing in the layer. The layer is formed, using a phosphorescent phosphor powder, wherein a metal oxide powder whose primary particles have a particle-size distribution with an upper limit particle size smaller than a lower limit particle size of a particle-size distribution that primary particles of a matrix material of the phosphorescent phosphor powder have is mixed, in a ratio by weight that is not less than 10 wt % but not greater than 40 wt %, with the matrix material of the phosphorescent phosphor powder. Therein, the particles of the metal oxide fill the gaps among the particles of the phosphorescent phosphor, and thereby the adhesive strength between the particles of the phosphorescent phosphor is heightened.

### BACKGROUND OF THE INVENTION

1. Field of the Invention

The present invention relates to a phosphorescent phosphor powder, a manufacturing method thereof and an afterglow fluorescent lamp, and more particularly to prevention of peeling-off of a phosphorescent phosphor layer in an afterglow fluorescent lamp wherein a phosphorescent phosphor is utilized.

2. Description of the Related Art

The afterglow fluorescent lamp makes good use of characteristics (the phosphorescent natures or the long afterglow properties) that the phosphorescent phosphor has, that is, the capabilities to keep glowing persistently for a considerable time after the cessation of the stimulus. Since the lamp remains luminous even after the external power supply is cut off, it is used in the space where a large number of people gather, for instance, a large-sized store, a theater or an underground shopping complex for the general lighting and, at the same time, for the means to indicate the escape routes in case of power failure.

In FIG. 1, a side view (FIG. 1(a)) and a cross-sectional view (FIG. 1(b)) of one example of such an afterglow fluorescent lamp are shown. The lamp shown in the drawing is an afterglow fluorescent lamp disclosed in FIG. 3 of Japanese Patent Application Laid-open No. 144683/1999.

Referring to FIG. 1, the construction of the afterglow fluorescent lamp is described below. A straight tube-shaped glass container 1 provides a hollow, airtight space (the discharge space). In the discharge space, as a discharge medium gas 2, a mixed gas of mercury vapor and a rare gas such as argon or xenon are sealed. The pressure therein is, in general, set 200 Pa to 400 Pa (1.5 Torr to 3.0 Torr) or so. The mercury is, in the first place, sealed in the glass container in the form of a drop, and brought into a state in which mercury in liquid phase and mercury in gas phase, with a vapor pressure that varies with the lamp temperature, coexist.

The inner surface of the glass container 1 is coated with layers of a transparent, conductive layer 3, a phosphorescent phosphor layer 4 and a RGB (red, green and blue) three emission bands type phosphor layer 5, being formed in this order. Further, to generate an electrical discharge in the discharge space, a pair of electrodes 6A and 6B is disposed at either end inside of the glass container. Each of these electrodes 6A and 6B is a thermionic electrode wherein a filament is coated with an emission material.

In the afterglow fluorescent lamp shown in the drawing, thermoelectrons are made liberated from the electrodes when the electrode filaments are warmed up enough by the electric current passing therethrough. With a potential difference being applied between these two electrodes 6A and 6B, the emitted thermoelectorons are led by an electric field generated between the electrodes 6A and 6B, travelled towards one of the electrodes. The thermoelectrons, hereat, collide with atoms of the vaporized mercury inside the glass container, and, obtaining energy thereby, the mercury atoms emit ultraviolet radiation. The ultraviolet radiation from the mercury atoms excites the three emission bands type phosphor layer 5 and the phosphorescent phosphor layer 4 and makes them emit visible light such as white light or daylight. While emission of the phosphorescent phosphor layer 4 is hereat brought about by the ultraviolet radiation sent forth by the mercury atoms, the phosphorescent phosphor layer 4 accumulates energy obtained from the ultraviolet radiation, and continues to emit light even after its excitation by the ultraviolet radiation is stopped.

In the manner of the operations described above, the afterglow fluorescent lamp is luminous mainly due to the emission of the three emission bands type phosphor layer 5, as long as the electric power is externally supplied, but after the power supply is cut off, in other words, after the excitation by the ultraviolet radiation sent forth by the mercury atoms stops in the absence of the electric discharge, the afterglow fluorescent lamp remains glowing owing to the function of the phosphorescent phosphor layer 4.

Over the internal surface of the glass container 1, a conductive coating 3 laid beneath the phosphorescent phosphor layer 4 is formed for the sole purpose of using this afterglow fluorescent lamp as a rapid-start type discharge lamp in the mode of the conductive internal coating. For instance, as a glow-start type lamp, the conductive coating 3 is not particularly required.

For the phosphorescent phosphor layer 4, as described in Japanese Patent Application Laid-open No. 144683/1999 and Japanese Patent Application Laid-open No. 011250/1995, a phosphor containing a compound of the formula MAl₂O₃ (where M is one or more metal elements selected from the group consisting of Ca, Sr and Ba) as a host crystal and utilizing at least one of Eu, Dy and Nd as an activator or a coactivator is in use. Other examples include a phosphorescent phosphor containing a compound Y₂O₂S as a host crystal and utilizing at least one of Eu, Mg and Ti as an activator or a coactivator.

In the case that, as soda lime glass, the material of the glass container 1 contains the soda component, the soda component may separate out of the glass container after long use, and, together with mercury, may come into contact with the phosphorescent phosphor layer 4, and deteriorate the phosphorescent phosphor layer 4 gradually. In an afterglow fluorescent lamp described in Japanese Patent Application Laid-open No. 144683/1999, with the object of preventing deterioration of the phosphorescent phosphor layer 4, 0.1 wt % to 10 wt % of ultra-fine particles of metal oxide, for instance, alumina powder with an average particle size of 0.1 μm or less are comprised in the phosphorescent phosphor layer 4.

The inventors noticed that in the afterglow fluorescent lamp shown in FIG. 1, as the time for its use lengthens, there arises a phenomenon referred to as “pinholes”, wherein the storing-light phosphor layer 4 peels off in the form of a sprinkle of small holes from the internal surface of the glass container 1, and cannot be restored. Once the pinholes are formed, the sections of the phosphorescent phosphor layer 4 where the peeling-off have actually occurred look clearly different, even to the naked eyes, from the sections where the phosphor layer are still intact so that the appearance of the fluorescent lamp becomes marred. Moreover, a lack of the phosphorescent phosphor layer in those sections of pinholes lowers the light emission intensity of the lamp.

The pinholes described above were also observed in the lamps other than the rapid-start type ones, although no conductive coating 3 is provided. Further, they were also found in the lamps without a three emission bands type phosphor layer 5 but only with a phosphorescent phosphor layer 4. Even when the glass container is made of a material containing no soda component, for instance, a material of vitreous silica, pinholes were observed. It was, therefore, concluded that the formation of the pinholes is caused by the phosphorescent phosphor layer 4 itself.

Accordingly, an object of the present invention is to prevent pinholes from appearing in a phosphorescent phosphor layer in an afterglow fluorescent lamp having a structure wherein at least a phosphorescent phosphor layer is set on the internal surface of the container which provides the discharge space.

### SUMMARY OF THE INVENTION

The present invention relates to a phosphorescent phosphor powder, wherein a metal oxide powder whose primary particles have a particle-size distribution with an upper limit particle size smaller than a lower limit particle size of a particle-size distribution that primary particles of a matrix material of the phosphorescent phosphor powder have is mixed, in a ratio by weight that is not less than 10 wt % but not greater than 40 wt %, with said matrix material of the phosphorescent phosphor powder.

Further, the present invention relates to an afterglow fluorescent lamp; which at least comprises:
a transparent container which forms a hollow, air-tight space;
a discharge medium gas comprising mercury vapor, which is contained in an internal space of said container;
electrodes for generating an electrical discharge in the internal space of said container with said gas being used as a medium; and
a phosphorescent phosphor layer set on an internal surface of said container, which is formed, using a phosphorescent phosphor powder described above.

An afterglow fluorescent lamp according to the present invention has a structure wherein at least a phosphorescent phosphor layer is set on the internal surface of the container forming a discharge space, and therein pinholes can be prevented from appearing in the phosphorescent phosphor layer. An application of the present invention to an afterglow fluorescent lamp can prevent the pinhole formation therein, while an application to a rapid-start type fluorescence lamp in the mode of the conductive internal coating can suppress the formation of dark spots referred to as “sanding” in the phosphor layer thereof.

### BRIEF DESCRIPTION OF THE DRAWING

FIG. 1 is a pair of a side elevation view, partly broken away to show details and a cross-sectional view of an afterglow fluorescent lamp.

### DETAILED DESCRIPTION OF THE INVENTION AND PREFERRED EMBODIMENTS

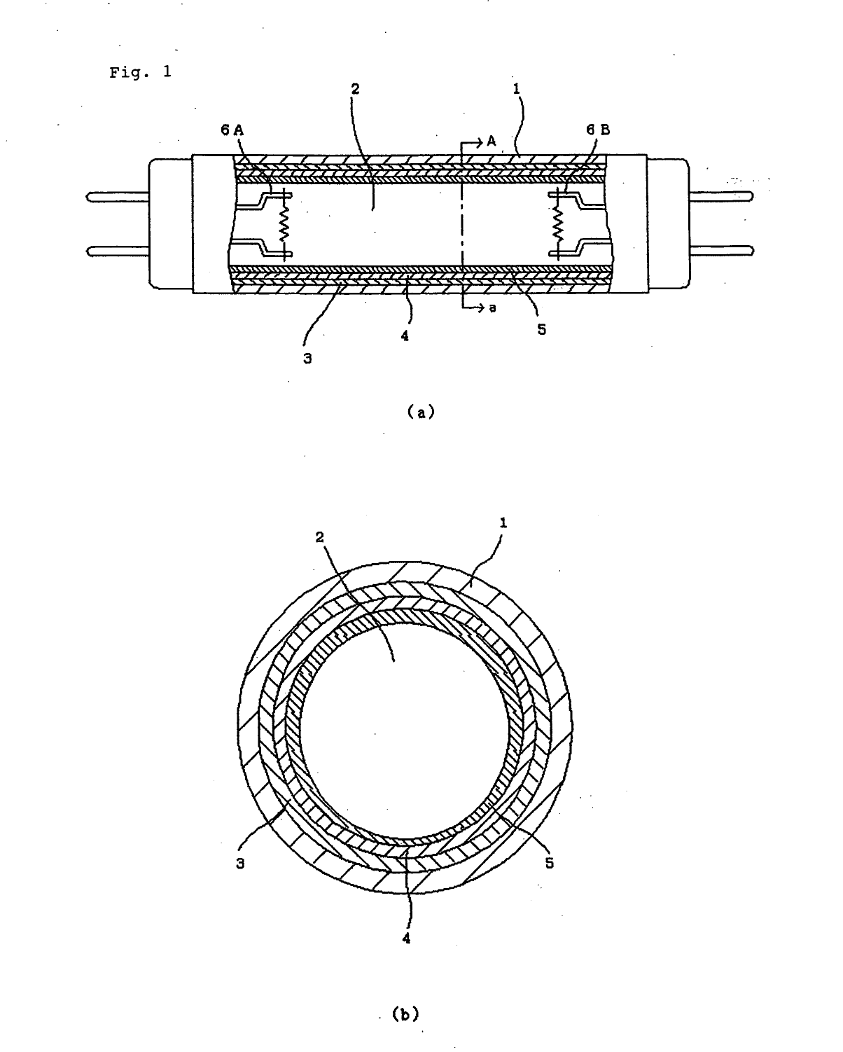

Next, referring to the drawing, the preferred embodiments of the present invention are described below. An afterglow fluorescent lamp of one embodiment of the present invention, which has the same construction as shown in FIG. 1, is described in details with reference to FIG. 1.

In a hollow, airtight discharge space formed in a straight tube-shaped glass container 1, a discharge medium gas 2 composed of a mixed gas of mercury vapor and xenon is sealed. On the inner surface of the glass container 1, a conductive coating 3 made of SnO₂ is formed. On the conductive coating 3, a phosphorescent phosphor layer 4 of SrAl₂O₃: Eu, Dy is formed. Further, on the phosphorescent phosphor layer 4, a three emission bands type phosphor layer 5 is laid. The three emission bands type phosphor layer 5 is composed of a mixture of three phosphors of different emission bands, that is, a blue emission phosphor of BaMg₂Al₁₆O₁₇: Eu, Mn, a green emission phosphor of LaPO₄: Ce, Tb and a red emission phosphor of Y₂O₃: Eu.

The phosphorescent phosphor layer 4 contains ultra-fine particles of metal oxide. As a metal oxide, α-alumina, γ-alumina, TiO₂, SiO₂, MgO, Y₂O₃ or such is preferably used, but any other metal oxide may be utilized. For ultra-fine particles of the metal oxide, it is preferable to set the maximum particle size of its primary particles to be smaller than the minimum particle size of the phosphor in the phosphorescent phosphor layer 4, and is more effective to be contained in a ratio by weight ranging from 10 wt % to 40 wt % in the phosphorescent phosphor layer 4.

### EXAMPLE 1

For a phosphorescent phosphor layer 4, there was used a layer in which α-alumina particles with a size distribution of 0.3 μm to 5 μm were mixed with phosphor particles of SrAl₂O₃: Eu, Dy having an average particle size of 10 μm and a particle-size distribution of 5 μm to 20 μm. As for the content of the α-alumina particles in the phosphorescent phosphor layer, three levels of the content ratio by weight, 10 wt %, 20 wt % and 40 wt % were chosen to use.

### COMPARATIVE EXAMPLE

Afterglow fluorescent lamps each having the same structure as Example 1 except that a phosphorescent phosphor layer 4 herein did not contain α-alumina particles were fabricated.

Conducting the test of the repetitive lighting and lights-out for the afterglow fluorescent lamps of Example 1 and the afterglow fluorescent lamps of Comparative Example, the occurrences of the pinholes therein were examined. The test was carried out following a repetitive lighting scheme of a lighting-up for 2 hours 45 minutes and a lights-out for next 15 minutes, which summed up to 22 hours of the burning hours and 3 hours of off time a day in total. The results of the test are shown in Table 1. In Table 1, a mark with a circle indicates no detection of pinholes visible to the eyes, while a mark with a cross indicates a detection of pinholes visible to the eyes.

TABLE 1

| α-alumina | |
|---|---|
| Content Ratio | Testing Time Period (h) |

| Sample | (wt %) | 0 | 100 | 500 | 1000 |
|---|---|---|---|---|---|
| Example 1 | 40 | ◯ | ◯ | ◯ | ◯ |
| | 20 | ◯ | ◯ | ◯ | ◯ |
| | 10 | ◯ | ◯ | ◯ | ◯ |
| Case 1 for | 0 | ◯ | ◯ | x | x |
| Comparison | | | | | |

As shown in Table 1, in Case 1 for Comparison wherein no α-alumina particles were contained, pinholes started appearing after 500 hours into the test. In contrast to this, in the lamp of Example 1, with any level of the particle content ratio, the appearance of the pinholes was not observed in the slightest after 1000 hours into the test, and the effects of the present invention were confirmed.

When the content ratio of the α-alumina particles was 40 wt % or higher, the effects of suppressing the pinhole appearance were clearly observed. However, once the content ratio exceeded 40 wt %, the transmission of the visible light for the phosphorescent phosphor layer 4 started decreasing so that it is preferable to set the content ratio not greater than 40 wt %. On the other hand, when the content ratio was not greater than 5 wt %, pinholes started showing at about the same time as in Case for Comparison and no effects of the present invention were recognized. The content ratio of α-alumina particles in the phosphorescent phosphor layer 4 is, therefore, preferably set to be 10 wt % to 40 wt %.

Further, for the rapid-start type fluorescence lamp in the mode of the conductive internal coating known to be liable to get, in the phosphor layer, dark spots, which are referred to as “sanding” and cause disfigurement, an advantageous side effect of suppressing formation of such sanding was obtained in the present Example.

Next, a method of forming a phosphorescent phosphor layer 4 is described below.

In Case for Comparison, there was employed a conventional method, which comprises the steps of making a suspension in which a phosphorescent phosphor powder, the material of the layer, is dispersed in a solvent and applying coating of that suspension onto the internal surface of the glass container and then making that dry.

Meanwhile, in Example 1, a suspension was first made by dispersing a powder of a phosphorescent phosphor in a solvent. Another suspension was then separately made by dispersing a powder of α-alumina in another solvent. After that, by mixing these two separate suspensions together, a suspension containing both of the phosphorescent phosphor powder and the α-alumina powder was prepared.

As a method of forming a phosphorescent phosphor layer 4, a method of dispersing the phosphorescent phosphor powder and the α-alumina powder in one solvent from the beginning may be considered plausible, but, in practice, it was very difficult to make a suspension in which the α-alumina powder was uniformly dispersed in the state of the primary particles. It is well known that, when very fine, powder particles tend to aggregate to form secondary particles with greater article sizes, and a fact that the α-alumina powder used in the present example was of ultra-fine particles is thought to be a very cause of the afore-mentioned problem. By the same token, the aggregation of the α-alumina could be successfully avoided by preparing the suspension of the phosphorescent phosphor powder and the suspension of the α-alumina powder, separately, as in Example 1.

In the present example, the phosphorescent phosphor layer 4 was formed by applying coating of the suspension onto the glass container, immediately after its preparation. It is, however, possible that after making the solvent evaporate once from the suspension and collecting a mixed powder of the phosphorescent phosphor powder and the α-alumina powder, the mixed powder is again dispersed into a solvent and this is used for formation of the phosphorescent phosphor layer 4. In any event, no difference in effects of preventing the pinhole appearance or in effects of suppressing the sanding phenomenon was found.

### EXAMPLE 2

Afterglow fluorescent lamps each with the same structure as Example 1 were fabricated, using the same manufacturing method as Example 1 except that γ-alumina particles, instead of α-alumina particles, were contained in the phosphorescent phosphor layer 4.

The same test as performed in Example 1 was conducted for the fabricated lamps, and the same results as shown in Table 1 were obtained. Further, the effects of suppressing the sanding phenomenon were also obtained as Example 1.

### EXAMPLE 3

Afterglow fluorescent lamps with the same structure as Example 1 were fabricated, using the same manufacturing method as Example 1 except that a mixed powder of α-alumina particles and γ-alumina particles, which were used in Example 1 and Example 2, respectively, were contained in the phosphorescent phosphor layer 4.

The same test as performed in Example 1 was conducted for the fabricated lamps, and the same results as shown in Table 1 were obtained. No difference in effects between lamps with different content ratios of α-alumina and γ-alumina was found. Further, the effects of suppressing the sanding phenomenon were also obtained as Example 1.

The reason why, in Examples 1 to 3, the addition of α-alumina particles, γ-alumina particles or a mixed powder of α-alumina particles and γ-alumina particles in the phosphorescent phosphor layer 4 suppressed the pinhole appearance is thought as follows.

As described above, mercury exists in liquid phase when the lamp is cooled down, and in gas phase when the temperature of the lamp is raised owing to the electric discharge. Accordingly, every time the lamp is switched on or off, the mercury in the discharge space is made to convert from one phase to the other through vaporization or condensation.

Now, when the mercury in gas phase condenses to the mercury in liquid phase, the mercury attaches to the internal wall of the glass container. In this instance, the mercury in gas phase tends to enter gaps among particles in the phosphor layer and converts to the mercury in liquid phase therein. At the time of this condensation, phosphor particles may be lifted up by the surface tension of the liquefied mercury. When the lamp is subsequently re-lighted and warmed up, the liquid mercury lodging inside of the phosphor layer may take off together phosphor particles which have already lost adhesive strength, in vaporizing, whereby pinholes are left behind.

Now, it is generally known that characteristics of the phosphor depend on the primary particle size of the phosphor particles and its light emission efficiency increases with the size of the phosphor particles. Further, it is a well-known fact that the phosphorescent phosphor is, for that reason, made to have greater particle size than other phosphors such as three emission bands type phosphor which are primarily used for illumination.

For example, while the particle-size distribution of the three emission bands type phosphor normally ranges from 3 μm to 5 μm, the particle-size distribution of SrAl₂O₃: Eu, Dy used in Examples 1 to 3 ranges from 5 μm to 20 μm. The phosphorescent phosphor of this sort is a phosphor containing a compound having the general formula MAl₂O₃ (where M is one or more metal elements selected from the group consisting of Ca, Sr and Ba) as a host crystal and utilizing at least one of Eu, Dy and Nd as an activator or a coactivator, and, in any case, has the particle-size distribution of 3 μm to 30 μm or so, approximately. Other examples of a phosphorescent phosphor include a phosphorescent phosphor containing a compound Y₂O₂S as a host crystal and utilizing at least one of Eu, Mg and Ti as an activator or a coactivator, and ZnS, which is, for example, described in Japanese Patent Application Laid-open No. 265946/1997, and their particle sizes are also substantially large.

In the phosphorescent phosphor layer, with the particle size of crystalline particles of the phosphorescent phosphor distributing approximately in a region of 5 μm to 30 μm or so, as described above, the diameter of the crystalline particles constituting the layer is large and, consequently, the gaps among particles become large. As a result, mercury can easily enter the inside of the phosphorescent phosphor layer and, therein, the condensation and evaporation of mercury are liable to take place. In short, the peeling-off of the layer and the pinhole formation are liable to occur in the phosphorescent phosphor layer.

Now, if particles of the metal oxide which are smaller than the particles of the phosphorescent phosphor are comprised in the phosphorescent phosphor layer 4, the ultra-fine particles of the metal oxide get into the gaps among crystalline particles of the phosphorescent phosphor. This heightens the adhesive strength between crystalline particles of the phosphorescent phosphor and, at the same time, prevents the condensed mercury from entering the gaps among crystalline particles of the phosphor, with the gaps being filled therewith. This suppresses the pinhole formation in the phosphorescent phosphor layer 4.

In Example 1, the phosphorescent phosphor SrAl₂O₃: Eu, Dy had an average particle size of 10 μm and a particle-size distribution of 5 μm to 20 μm, while α-alumina which was added thereinto had a particle-size distribution of 0.3 μm to 5 μm. Apparently, this satisfies the afore-mentioned conditions that the particle size of the α-alumina should be smaller than that of the phosphorescent phosphor. This is thought to be the very reason why the pinhole formation in the phosphorescent phosphor layer 4 could be well prevented in Example 1. The γ-alumina used in Examples 2 and 3 is alumina having a different crystalline structure from the one α-alumina has, and because γ-alumina is generally characterized by the particle distribution which is, compared with that of α-alumina, shifted towards smaller sizes, γ-alumina is considered to be better suited than α-alumina for that purpose.

Next, the reason why the sanding phenomenon was well suppressed in Examples 1 to 3 is thought to be as follows. In the rapid-start type fluorescent lamp, by applying a conductive coating 3 onto the internal surface of the lamp tube container 1, the tube wall electric resistance is reduced and the lamp is made to start more readily. Now, while lighting, superfluous mercury in the glass container in the fluorescent lamp condenses in its cooler section and adheres onto the surface of the phosphor layer, in the shape of a sphere. This leads to the formation of a sort of a capacitor with the phosphor layer functioning as the dielectric and the mercury and the conductive coating 3, as a pair of electrodes facing to each other. While the fluorescent lamp carries the electric discharge, electric charges are stored in this capacitor, but, if the field strength applied to the phosphor layer exceeds the dielectric strength of the phosphor layer, the dielectric breakdown arises between the mercury and the conductive coating 3. The discharge energy released at the time of that dielectric breakdown makes the phosphor layer scattered and the mercury oxidized or amalgamated, leading to discoloration of the phosphor layer and the conductive coating 3. This discoloration becomes black spots and results in disfigurement called sanding.

If mercury can easily enter the inside of the phosphor layer, the effective thickness of the phosphor layer is reduced that much, and the dielectric breakdown of the phosphor layer becomes more liable to happen. Against this, in Examples 1 to 3, metal oxide which is an insulating substance filled the gaps among crystalline particles of the phosphorescent phosphor powder 4 and thereby prevented mercury from getting into the gaps. As a result, the original dielectric strength of the phosphorescent phosphor layer 4 was maintained, which certainly hindered the sanding phenomenon from occurring.

Accordingly, with regard to the metal oxide that is to be contained in the phosphorescent phosphor layer 4, it can be anticipated that not only alumina but also any metal oxide can obtain similar effects to those obtained in Examples 1 to 3 as long as the upper limit of the particle size distribution for its primary particles is smaller than the lower limit of the particle-size distribution of the phosphorescent phosphor powder. In particular, titanium oxide (TiO₂), magnesium oxide (MgO) silicon oxide (SiO₂) or yttrium oxide (Y₂O₃) is preferable.

The metal oxides given above are conventional materials which are in good use not only for the phosphorescent fluorescent lamp but also for the fluorescence lamps in various other forms. In their application to the fluorescent lamp, therefore, their characteristics and properties as well as handling methods, manufacturing methods and such have been already well studied, and besides those materials are readily available. Further, although some of other metal oxides such as iron oxide which is reddish brown may give an unaccustomed, uneasy appearance if used in the discharge lamp, the use of any of the afore-mentioned metal oxides can avoid such unfavorable side effects these colored metal oxides have.

Now, Examples 1 to 3 are examples of an afterglow fluorescent lamp with a structure wherein a three emission bands type phosphor layer 5 is laid on the phosphorescent phosphor layer 4. For the afterglow fluorescent lamp with a structure wherein, instead of setting two different phosphor layers, the three emission bands type phosphor was comprised in the phosphorescent phosphor layer 4, the present inventors also conducted investigations on the effects of preventing the pinhole formation and the effects of suppressing the sanding phenomenon. The results confirmed the same effects as Examples 1 to 3 can be obtained for the lamp having this structure.

With the structure wherein three emission bands type phosphor is comprised in the phosphorescent phosphor layer 4, the light intensity of the visible light decreases, but this structure has an advantage that formation of the phosphor layer can be completed in one step in the manufacturing method of a lamp.

Further, although a lamp in the shape of a straight tube was used in Examples it is to be understood that the present invention is not limited to this. For instance, the glass container 1 can be a ball-shaped one. Moreover, the lamp can be certainly a ring-shaped lamp or a compact type fluorescent lamp which is in structure a combination of a plurality of U-shaped lamps, U-shaped lamps being formed by bending straight tube-shaped lamps.

1. A phosphorescent phosphor powder, wherein a metal oxide powder whose primary particles have a particle-size distribution with an upper limit particle size smaller than a lower limit particle size of a particle-size distribution that primary particles of a matrix material of the phosphorescent phosphor powder have is mixed, in a ratio by weight that is not less than 10 wt % but not greater than 40 wt %, with said matrix material of the phosphorescent phosphor powder.

2. A phosphorescent phosphor powder according to claim 1, wherein said metal oxide powder is a powder of any one sort or a mixed powder of a plurality of sorts selected from the group consisting of an α-alumina powder, a γ-alumina powder, a titanium oxide powder, a magnesium oxide powder, a silicon oxide powder and a yttrium oxide powder.

3. A phosphorescent phosphor powder according to claim 1; wherein said matrix material of the phosphorescent phosphor powder is either
a phosphor powder comprising a compound of the general formula MAl₂O₃ (wherein M is one or more metal elements selected from the group consisting of Ca, Sr and Ba) as a host crystal and utilizing at least one of Eu, Dy and Nd as an activator or a coactivator; or
a phosphor powder comprising Y₂O₂S as a host crystal and utilizing at least one of Eu, Mg and Ti as an activator or a coactivator.

4. A phosphorescent phosphor powder, wherein a phosphorescent phosphor powder according to one of claim 1 is mixed with a three emission bands type phosphor powder.

5. A method of manufacturing a phosphorescent phosphor powder according to claim 1; which comprises the steps of:
dispersing a matrix material of the phosphorescent phosphor powder in a first solvent to obtain a first suspension;
dispersing a metal oxide powder whose primary particles have a particle-size distribution with an upper limit particle size smaller than a lower limit particle size of a particle-size distribution that primary particles of said matrix material of the phosphorescent phosphor powder have in a second solvent to obtain a second suspension; and
mixing said first suspension and said second suspension together.

6. An afterglow fluorescent lamp; which at least comprises:
a transparent container which forms a hollow, airtight space;
a discharge medium gas comprising mercury vapor, which is contained in an internal space of said container;
electrodes for generating an electrical discharge in the internal space of said container with said gas being used as a medium; and
a phosphorescent phosphor layer set on an internal surface of said container, which is formed, using a phosphorescent phosphor powder according to one of claims 1.

7. An afterglow fluorescent lamp according to claim 6, which further comprises a three emission bands type phosphor layer laid on said phosphorescent phosphor layer.

8. An afterglow fluorescent lamp according to claim 6, wherein said phosphorescent phosphor layer contains a three emission bands type phosphor.

9. An afterglow fluorescent lamp according to one of claims 6, which is a rapid-start type fluorescent lamp in the mode of the conductive internal coating with a structure wherein a conductive coating is set between said internal surface of the container and said phosphorescent phosphor layer.

10. An afterglow fluorescent lamp; which at least comprises:
a tube-shaped glass container which forms a hollow, airtight space;
a discharge medium gas made of a mixed gas of a noble gas and mercury vapor, which is contained in an internal space of said container;
electrodes for generating an electrical discharge in the internal space of said container with said gas being used as a medium; and
a phosphorescent phosphor layer set on an internal surface of said container, which is formed, using a phosphorescent phosphor powder according to one of claims 1.

11. An afterglow fluorescent lamp according to claim 10, which further comprises a three emission bands type phosphor layer laid on said phosphorescent phosphor layer.

12. An afterglow fluorescent lamp according to claim 10, wherein said phosphorescent phosphor layer contains a three emission bands type phosphor.

13. An afterglow fluorescent lamp according to one of claims 10, which is a rapid-start type fluorescent lamp in the mode of the conductive internal coating with a structure wherein a conductive coating is set between said internal surface of the container and said phosphorescent phosphor layer.
